(19) United States
(12) Patent Application Publication
(10) Pub. No.: US 2003/0095137 A1
(43) Pub. Date: May 22, 2003

(54) Apparatus and method for clipping primitives in a computer graphics system

(76) Inventors: Chung-Yen Lu, Taipei (TW); Hsiang-Chi Lin, Taipei (TW)

Correspondence Address: BIRCH STEWART KOLASCH & BIRCH, PO BOX 747, FALLS CHURCH, VA, 22040-0747, US

(21) Appl. No.: 09/988,044

(22) Filed: Nov. 16, 2001

(51) Int. Cl. G09G 5/00

(52) U.S. Cl. 345/660

(57) ABSTRACT

An apparatus and method for reducing clipping computations needed to perform clipping of an input primitive in a clipping machine of a computer graphics system. The present invention provides an intersection cache storing the previous clipped vertex data for reuse in the following operations, thus dramatically reducing the amount of data calculation. The method includes providing a plane identification designated to a clipping plane and a pair of vertex indices designated to an edge of the graphics primitive, comparing the plane identification and the pair of vertex indices with a cached plane identification and a pair of cached vertex indices, determining a result from the comparing step, and retrieving cached vertex data as clipped vertex data defining a clipped primitive if the result is indicative of a cache hit status.

### FIELD OF THE INVENTION

The present invention relates generally to computer graphics systems and, in particular, to clipping machines having an intersection cache that clips graphics primitives to one or more boundaries.

### BACKGROUND OF THE INVENTION

Computer graphics systems are commonly used for displaying graphical representations of objects on a two-dimensional display screen. Current computer graphics systems can provide highly detailed representations and are used in a variety of applications.

In typical computer graphics systems, an object to be represented on the display screen is broken down into a plurality of graphics primitives. Primitives are basic components of a graphics picture and may include points, lines, and polygons, such as triangles or quadrilaterals. Typically, a hardware/software scheme is implemented to render, or draw, on the two-dimensional display screen, the graphics primitives that represent the view of one or more objects being represented on the screen.

Generally, the primitives that define the three-dimensional object to be rendered are provided from a host computer, which defines each primitive in terms of primitive data. For example, when the primitive is a triangle, the host computer may define the primitive in terms of the X, Y, Z coordinates of its vertices, as well as the R, G, B color values of each vertex. Rendering hardware interpolates the primitive data to compute the display screen pixels that are turned on to represent each primitive, and the R, G, B values for each pixel.

One of the more complex operations that may be performed by a clipping machine of a computer graphics system is the clipping of graphics primitives. Clipping determines which portion of a graphics primitive is to be displayed in what known as a “clip region”. The clipping region can be a two-dimensional area such as window, or it can be a three-dimensional view volume. The primitives being displayed in the clip region can be one-dimensional (e.g., lines) or two-dimensional (e.g., polygons).

Various techniques have been developed for clipping points, lines, and polygons. These techniques are computationally intensive graphics manipulations, especially when applied to clipping polygons against three-dimensional clip regions.

To speed up operation of computer graphics systems, it is common to implement special-purpose circuitry dedicated to clipping operations. Nonetheless, the need exists for additional improvements in performance. In particular, the need exists for reducing clipping computations performed by the clipping machines.

### SUMMARY OF THE INVENTION

It is an object of the present invention to provide an apparatus and method for reducing clipping computations needed to perform clipping of an input primitive in a clipping machine of a computer graphics system.

The present invention is an intersection cache for use in a clipping machine of a computer graphics system. The intersection cache includes an intersection buffer, a tag unit and a cache controller. The intersection buffer stores intersection data that is clipped vertex data associated with an intersection. The tag unit has at least one tag corresponding to the intersection data. The tag unit receives as input one plane identification (PID) and a pair of vertex indices (VID₁, VID₂) and provides as output a return signal. Further, the tag unit searches the at least one tag for a matched tag matching the received plane identification and the received pair of vertex indices. The tag unit issues the return signal indicative of a hit status and provides a buffer address if the matched tag exists, otherwise, the tag unit issues the return signal indicative of a miss status if there is no matched tag. The cache controller receives as input the return signal. The cache controller instructs the intersection buffer to provide the intersection data according to the buffer address associated with the matched tag when the return signal is indicative of the hit status. On the other hand, the cache controller stores new intersection data in the intersection buffer and updates the tag unit with a new tag corresponding to the new intersection data and a new address associated with the new tag when the return signal is indicative of the miss status. The new address is used to access the new intersection data in the intersection buffer.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram of an exemplary computer graphics system suitable for incorporating a geometry subsystem according to the present invention;

FIG. 2 is a block diagram of a geometry subsystem that includes a clipping machine according to the present invention;

FIG. 3 is a block diagram of a clipping machine according to an embodiment of the present invention;

FIG. 4A illustrates a diagram of an input primitive being clipped to a two-dimensional clipping boundary;

FIG. 4B illustrates a resulting clipped geometry formed by clipping the input primitive to clipping planes X_{MIN}, X_{MAX}, Y_{MIN}, and Y_{MAX};

FIG. 4C shows three adjoining primitives representing a view of one object are clipped to a two-dimensional clipping boundary;

FIG. 5 is a block diagram of an intersection cache according to an embodiment of the present invention; and FIG. 6 illustrates a flowchart exemplifying the operation of a clipping machine with an intersection cache according to an embodiment of the present invention.

### DETAILED DESCRIPTION OF THE PREFERRED EMBODIMENT

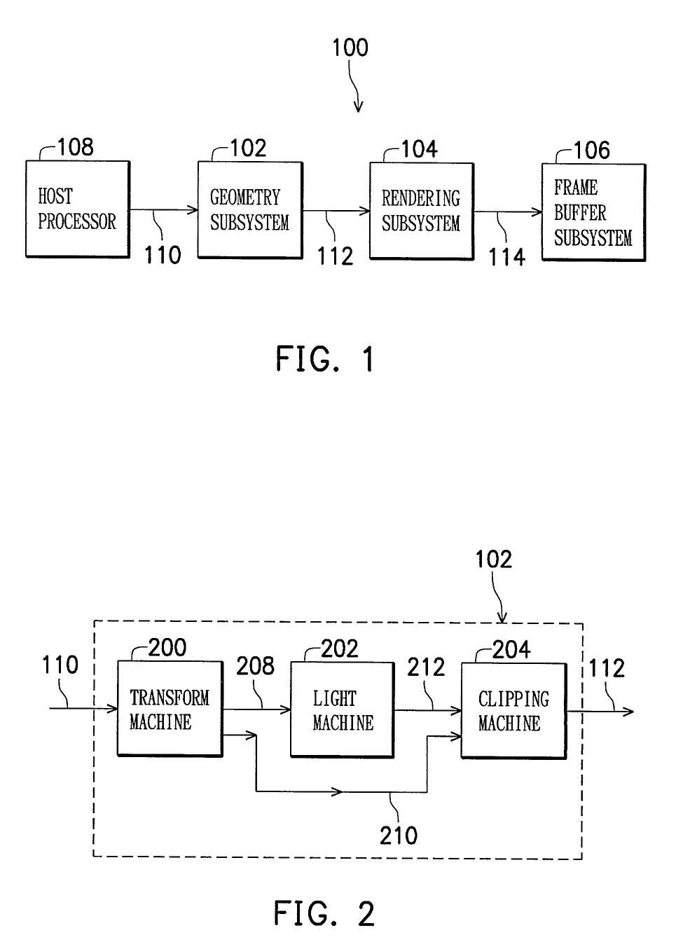

As illustrated in FIG. 1, an exemplary computer graphics system 100 is suitable for incorporation of a geometry subsystem including a clipping machine of the present invention. The graphics system 100 includes a geometry subsystem 102, a rendering subsystem 104 and a frame buffer subsystem 106. The geometry subsystem 102 receives primitives to be rendered from the host processor 108 over bus 110. The primitives are typically specified by X, Y, Z, and W coordinate data, N_{X}, N_{Y}, and N_{Z} normal data, R, G, B, and a color data, and S, T, R, and Q texture data for portions of the primitives, such as vertices.

Data representing the primitives in three dimensions is provided by the geometry subsystem 102 to the frame buffer subsystem 106 over bus 112 to the rendering subsystem 104. The rendering subsystem 104 may comprise a texture mapping machine that interpolates the received primitive data to compute the screen display pixels that will represent the primitive, and determine its corresponding resulting texture data for each primitive pixel. The resulting texture data is provided to the frame buffer subsystem 106 over bus 114. The rendering subsystem 104 determines object color values and Z values for each pixel. The rendering subsystem 104 combines, on a pixel-by-pixel basis, the object color values with the resulting texture data provided from the optional texture mapping machine, to generate resulting image R, G, B values for each pixel.

The geometry subsystem 102 receives the coordinate and other primitive data over bus 110 from a graphics application on the host processor 108. The geometry subsystem 102 manipulates the primitive data, including vertex state (coordinate) and property state (color, lighting, etc.) data. It generates rendering data, performs a floating point to fixed-point conversion if necessary, and provides the primitive data stream over bus 112 to the rendering subsystem 104.

The rendering subsystem 104 may be any well-known current or future system. Furthermore, the geometry subsystem 102 and the rendering subsystem 104 are preferably pipelined and operate on multiple primitives simultaneously. While the rendering subsystem 104 operates on primitives previously provided by the geometry subsystem 102, the geometry subsystem 102 continues to operate and provide new primitives until the pipelines in the subsystem 104 become full.

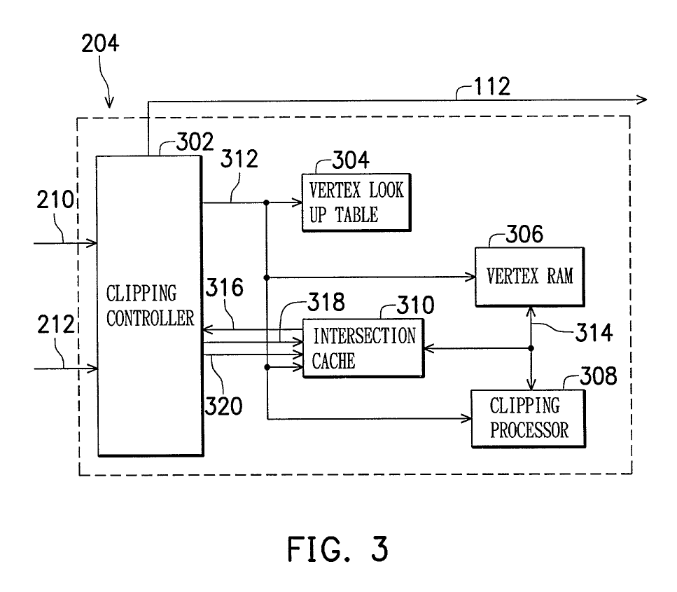

FIG. 2 shows a block diagram of a geometry subsystem 102 that includes a clipping machine 204 configured in accordance with the present invention. In one embodiment, the clipping machine 204 supports clipping on clipping planes at any orientation. As depicted, the geometry subsystem 102 includes a number of specialized machines, including a transform machine 200, a light machine 202 and a clipping machine 204. The transform machine 200 receives the primitive vertex data from the host processor 108 and performs transformations on the vertex data, such as scaling or moving a vertex in space. The transform machine 200 also calculates clip codes for each vertex of a primitive to determine whether the primitive may be trivially accepted or trivially rejected by the clipping machine 204. The calculation of clip codes and the determination of trivial acceptance and rejection are well known in the art and are not described in detail herein.

Briefly, when the clip codes indicate that each of the vertices of the primitive lie within the clipping volume, the primitive can be trivially accepted. Alternatively, when the clip codes indicate that each of the vertices of the primitive lie outside of one of the clipping of the clipping volume, the primitive can be trivially rejected. When the primitive is trivially rejected, the transformed vertex data is simply discarded by the transform machine 200 as it is completely outside the clipping boundaries, and a next primitive is processed.

However, when a primitive is not trivially rejected, the transformed vertex data is provided to the light machine 202 via bus 208. Based on the determination of trivial acceptance and rejection, the transform machine 200 provides control information to the clipping machine 204 via line 210 indicating whether the primitive is to be clipped, or not clipped at all. The transform machine 200 provides the clip codes to the clipping machine 204 via line 210 to control the operation of the clipping machine 204. When the clip codes indicate that the primitive can be trivially accepted, the primitive lies completely within the clipping boundaries and, therefore, does not need to be clipped. When the clip codes indicate that the primitive can neither be trivially accepted nor trivially rejected, the clipping machine 204 will be used to determine the intersections, if any, of the primitive with the clipping boundaries.

The light machine 202, as depicted, receives transformed vertex data for primitives that are not trivially rejected from the transform machine 200 via bus 208. The light machine 202 enhances image data by simulating light conditions, and provides the enhanced vertex data to the clipping machine 204 via bus 212. The clipping machine 204 receives the vertex data from the light machine 202, and determines what form of clipping, if any, is to be performed, on each primitive. The clipping machine 204 clips the primitive to the clipping boundaries and provides clipped vertex data to the rendering subsystem 104, via bus 112. In the event that the primitive is completely clipped away, that is, no portion of the primitive is within the clipping boundaries, no vertex data is provided to the rendering subsystem 104.

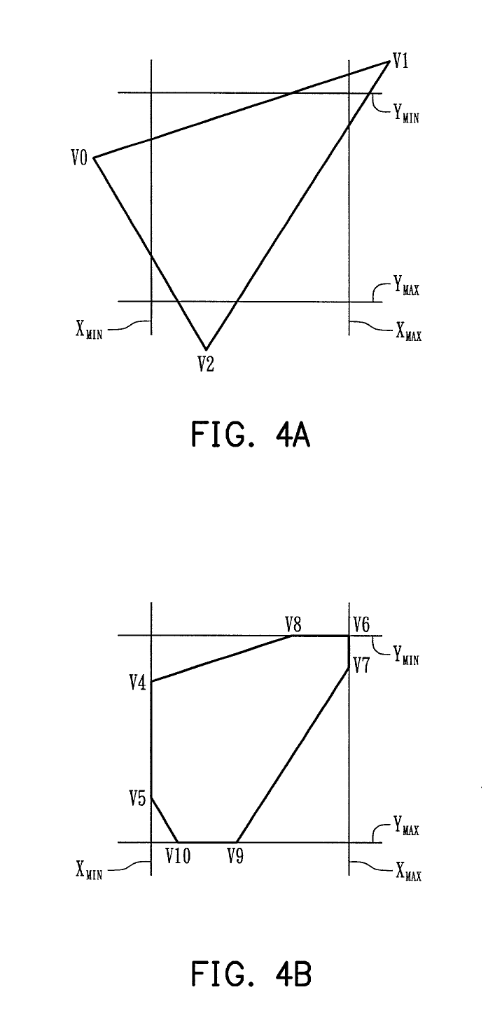

FIG. 3 is a block diagram of one embodiment of the clipping machine 204 according to the present invention. The clipping machine 204 includes a clipping controller 302, a vertex look up table (VLUT) 304, a vertex RAM (VRAM) 306, a clipping processor 308, and an intersection cache 310. The clipping controller 302 provides control signals via bus 312 to control the VLUT 304, the VRAM 306, the clipping processor 308 and the intersection cache 310. The VLUT 304 and the VRAM 306 need not be implemented within the clipping machine 204 as depicted in FIG. 3, but may be located anywhere within the geometry subsystem 102. The clipping controller 302 receives the control information, comprising the clip codes, via line 210, and the light-enhanced vertex data via bus 212, and instructs the clipping processor 308 to generate the clipped vertex data.

The clipping controller 302 stores the light-enhanced vertex data defining the input primitive in VRAM 306, and stores vertex indices corresponding to the vertex data that is stored in the VRAM 306 in the VLUT 304. The VRAM 306 has a number of locations to store vertex data. When the control information indicates that no clipping need be performed, the clipping controller 302 simply provides the light-enhanced vertex data to the rendering subsystem 104. This may occur, for example, when the input primitive lies completely within the clipping boundaries. Alternatively, when the control information indicates that clipping is to be performed, the clipping controller 302 instructs the intersection cache 310 and the clipping processor 308 to complete the clipping process. The vertex data are transmitted between the VRAM 306, the clipping processor 308, and the intersection cache 310 over bus 314.

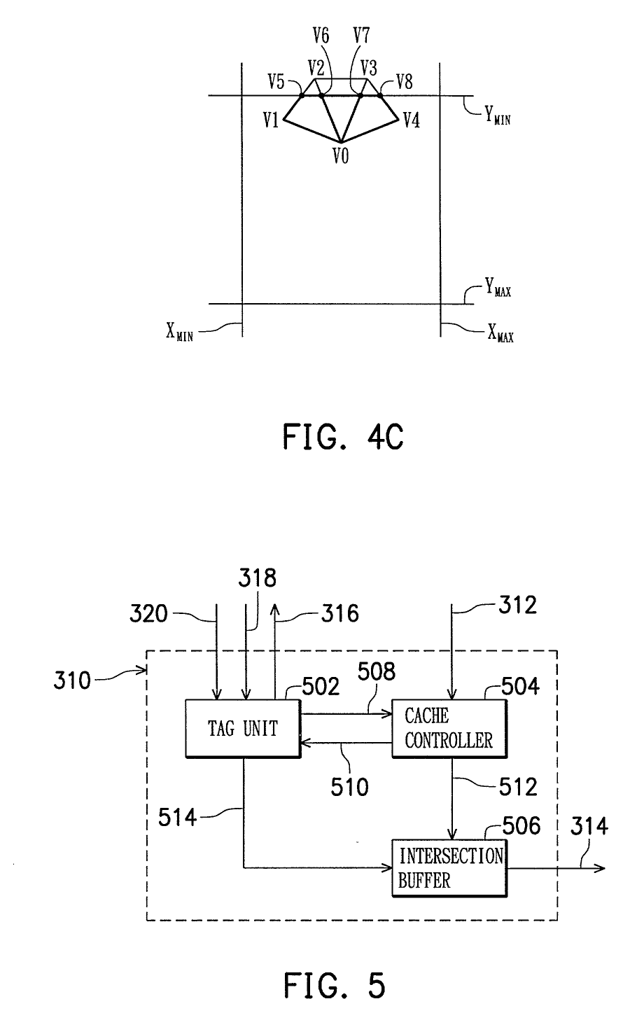

FIG. 4A illustrates a diagram of an input primitive being clipped to a two-dimensional clipping boundary defined by the planes X_{MIN}, X_{MAX}, Y_{MIN}, and Y_{MAX}. The clipping of the input primitive V0-V1-V2 is illustrated for convenience in only two dimensions, as the extension to three dimensions will be apparent to one of ordinary skill in the art. The clipping processor 308 clips each edge of the input primitive against the clipping plane X_{MIN} to generate a first set of output vertices. At first the intersection of edge V0-V1 results in a new vertex V4. The clipping processor 308 then processes edge V2-V0 and determines that a new vertex V5 is created. Likewise, the clipping processor 308 processes the remaining clipping planes X_{MAX}, Y_{MIN}, and Y_{MAX} successively. FIG. 4B illustrates the resulting clipped geometry V4-V5-V10-V9-V7-V6-V8 formed by clipping the input primitive to clipping planes X_{MIN}, X_{MAX}, Y_{MIN}, and Y_{MAX}.

In computer graphics, most primitives representing an object are adjacent. In FIG. 4C, three adjoining primitives representing a view of one object are clipped to a two-dimensional clipping boundary. As depicted, primitives V0-V1-V2 and V0-V2-V3 have a common edge V0-V2, and primitives V0-V2-V3 and V0-V3-V4 have a common edge V0-V3. The primitive V0-V1-V2 is clipped against a clipping plane Y_{MIN} and two clipped vertices V5 and V6 are created. Since the edge V0-V2 is the common edge of the primitives V0-V1-V2 and V0-V2-V3, the clipped vertex V6 is reused if it is cached in advance and a clipped vertex V7 is created when the primitive V0-V2-V3 is clipped against the clipping plane Y_{MIN}. Similarly, a resulting clipped geometry V0-V7-V8-V4 is formed by clipping the primitive V0-V3-V4 to clipping planes Y_{MIN}. In this way, storing the previous clipped vertex data for reuse, the clipping computations are dramatically decreased in accordance with the present invention.

With continued reference to FIG. 3, when a clipping plane clips an edge of a primitive, the clipping controller 302 firstly checks the intersection data of the clipping plane and the edge whether the intersection data could be found in the intersection cache 310. If a first signal 316 received from the intersection cache 310 indicates a cache miss status, the clipping controller 302 loads the indices of the vertices that define the input primitive into VLUT 304, and instructs the clipping processor 308 to determine the intersections of the input primitive with the appropriate clipping boundaries. However, if the first signal 316 indicates a cache hit status, the clipping controller 302 retrieves the intersection data from the intersection cache 310, loads it into the VRAM 306, and updates the VLUT 304. Hence, the clipping processor 308 performs nothing on this edge. The clipping processor 308 continues to clip the other edges of the input primitive, stores clipped vertex data in the VRAM 306, updates the vertex indices in the VLUT 304 to point to the clipped vertex data, and updates the edge information and intersection data associated with the edge information in the intersection cache 310. When control is returned to the clipping controller 302, the clipping controller 302 provides the clipped vertex data to the rendering subsystem 104 over bus 112.

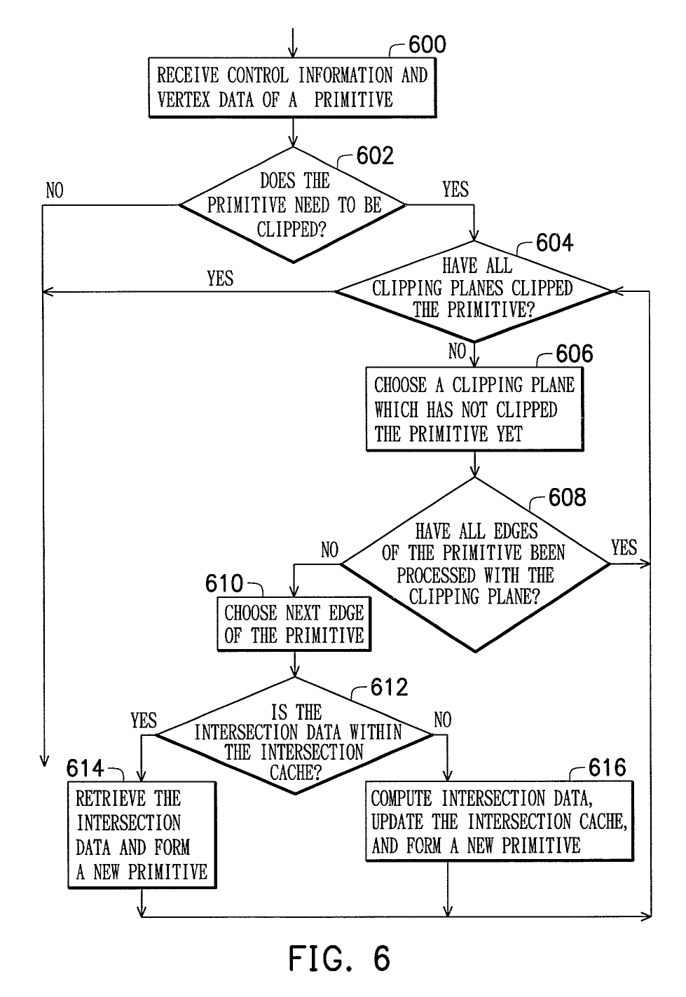

As shown in FIG. 5, a preferred embodiment of the intersection cache 310 includes a tag unit 502, a cache controller 504 and an intersection buffer 506. The intersection buffer 506 stores intersection data which is clipped vertex data associated with an intersection. The tag unit 502 is arranged to determine a cache hit or miss status. The tag unit has tags corresponding to the intersection data, and receives a PID 318 and a pair of vertex indices (VID₁, VID₂) 320 from the clipping controller 302. The tag unit 502 searches the tags for a matched tag matching the received PID 318 and the received pair (VID₁, VID₂) 320. The tag unit 502 issues a second signal 508 indicative of the cache hit status and provides a buffer address 514 associated with the matched tag if the matched tag exists. Otherwise, the tag unit 502 issues the second signal 508 indicative of the cache miss status if there is no matched tag.

As described above, a matched tag in the tag unit 502 means that there is a matched tag whose PID_{tag} and the received PID are the same, and whose (VID_{tag1}, VID_{tag2}) and the received pair (VID₁, VID₂) are the same. Since (VID₁, VID₂) and (VID₂, VID₁) represent the same edge, (VID_{tag1}, VID_{tag2}) and the received pair (VID₂, VID₁) are the same too.

The cache controller 504 instructs the intersection buffer 506 over bus 512, to provide the intersection data according to the buffer address 514 associated with the matched tag when the second signal 508 indicate the cache hit status. On the other hand, the cache controller 504 stores new intersection data in the intersection buffer 506 and updates the tag unit 502 with a new tag corresponding to the new intersection data and a new address associated with the new tag, via bus 510, when the second signal 508 indicates the cache miss status. The new address is used to point to the new intersection data in the intersection buffer 506. Further, the new tag comprises the received plane identification and the received pair of vertex indices. The new intersection data is the clipped vertex data computed by the clipping processor 308.

FIG. 6 illustrates a flowchart exemplifying the operation of a clipping machine 204 with an intersection cache 310. The clipping controller 302 receives the light-enhanced vertex data from the light machine 202 and control information from the transform machine 200 (step 600). The clipping controller 302 determines whether an input primitive will need to be clipped (step 602). If the input primitive should be clipped, the clipping machine 204 repeats the clipping procedures for processing all of the clipping planes (step 604). From the control information, the clipping machine 204 selects one of the clipping planes which clips the primitive but is not yet processed (step 606). When a clipping plane is determined, each edge of the primitive is clipped with the clipping plane one after one (steps 608˜610).

The clipping controller 302 instructs the intersection cache 310 to find an intersection that may save clipping computations of the edge. The intersection cache 310 compares a PID and a (VID₁, VID₂), received from the clipping controller 302, with each tag comprising a cached PID_{tag} and a cached (VID_{tag1}, VID_{tag2}) within the tag unit 502 (step 612). If a matched tag is found, the intersection cache reports a cache hit and provides cached vertex data as clipped vertex data forming a clipped primitive (step 614). Otherwise, the clipping processor 308 determines new clipped vertex data as the clipped vertex data by clipping the edge of the primitive with the clipping plane. The clipping controller 302 then instructs the clipping processor 308 to store the new clipped vertex data as new cached vertex data and to store the PID and the (VID₁, VID₂) as a new cached plane identification and a pair of new cached vertex indices (step 616).

Accordingly, an apparatus and method for reducing clipping computations in a clipping machine of a computer graphics system have been disclosed. It will be apparent that the invention is not limited thereto, and that many modifications and additions may be made within the scope of the invention. Therefore, it is the object of the appended claims to cover all such variations and modifications as come within the true spirit and scope of the invention.

What is claimed is:

1. An apparatus for use in a clipping machine of a computer graphics system, comprising:
an intersection buffer for storing intersection data which is clipped vertex data associated with an intersection;
a tag unit having at least one tag corresponding to the intersection data, receiving a plane identification and a pair of vertex indices and providing a return signal, for searching the at least one tag for a matched tag matching the received plane identification and the received pair of vertex indices, wherein the tag unit issues the return signal indicative of a hit status and provides a buffer address associated with the matched tag if the matched tag exists, and wherein the tag unit issues the return signal indicative of a miss status if there is no matched tag; and
a cache controller receiving the return signal, for instructing the intersection buffer to provide the intersection data according to the buffer address associated with the matched tag when the return signal is indicative of the hit status, and for storing new intersection data in the intersection buffer and for updating the tag unit with a new tag corresponding to the new intersection data and a new address associated with the new tag when the return signal is indicative of the miss status, wherein the new address points to the new intersection data in the intersection buffer.

2. The apparatus as recited in claim 1 wherein the new tag comprises the received plane identification and the received pair of vertex indices when the return signal is indicative of the miss status.

3. The apparatus as recited in claim 1 wherein the pair of vertex indices correspond to a pair of vertex data defining an edge of an input primitive.

4. The apparatus as recited in claim 3 wherein the intersection is a clipped vertex of the edge of the input primitive that is clipped against a clipping plane represented by the plane identification.

5. A clipping machine comprising:
a memory having memory locations;
a clipping processor for determining intersections of edges of an input primitive with at least one clipping plane and for storing clipped vertex data defining a clipped primitive in one of the memory locations, wherein the at least one clipping plane has a plane identification and each of the edges has a pair of vertex indices corresponding to a pair of vertex data defining the edge;
an intersection cache receiving the plane identification and the pair of vertex indices and providing a first signal, the intersection cache comprising at least one tag and intersection data corresponding to the tag, for searching the at least one tag for a matched tag matching the plane identification and the pair of vertex indices, wherein the intersection cache provides the first signal indicative of a hit status if the matched tag exists, and wherein the intersection cache provides the first signal indicative of a miss status if there is no matched tag; and
a clipping controller receiving the first signal from the intersection cache and providing the plane identification and the pair of vertex indices to the intersection cache, for instructing the clipping processor to update the intersection cache with the clipped vertex data when the first signal is indicative of the miss status, and for instructing the clipping processor to retrieve the intersection data from the intersection cache when the first signal is indicative of the hit status.

6. The apparatus as recited in claim 5 wherein the intersection cache comprises:
an intersection buffer for storing the intersection data which is the clipped vertex data associated with one of the intersections;
a tag unit having the at least one tag corresponding to the intersection data, the tag unit receiving the plane identification and the pair of vertex indices and providing a second signal, for searching the at least one tag for a tag matching the received plane identification and the received pair of vertex indices, wherein the tag unit issues the second signal indicative of the hit status and provides a buffer address associated with the matched tag if the matched tag exists, and wherein the tag unit issues the second signal indicative of the miss status if there is no matched tag; and
a cache controller receiving the second signal and providing the first signal, when the second signal is indicative of the hit status, the cache controller for issuing the first signal indicative of the hit status and for instructing the intersection buffer to provide the intersection data according to the buffer address associated with the matched tag, and when the second signal is indicative of the miss status, the cache controller for issuing the first signal indicative of the miss status, for storing new intersection data in the intersection buffer and for updating the tag unit with a new tag corresponding to the new intersection data and a new address associated with the new tag, wherein the new address points to the new intersection data in the intersection buffer.

7. The apparatus as recited in claim 6 wherein the new tag comprises the received plane identification and the received pair of vertex indices when the second signal is indicative of the miss status.

8. The apparatus as recited in claim 6 wherein the new intersection data is the clipped vertex data computed by the clipping processor.

9. A method of clipping a graphics primitive comprising:
providing a plane identification designated to a clipping plane and a pair of vertex indices designated to an edge of the graphics primitive;
comparing the plane identification and the pair of vertex indices with a cached plane identification and a pair of cached vertex indices;
determining a result from the comparing step; and
retrieving cached vertex data as clipped vertex data forming a clipped primitive if the result is indicative of a cache hit status.

10. The method as recited in claim 9 further comprising:
determining new clipped vertex data as the clipped vertex data forming the clipped primitive by clipping the edge of the graphics primitive with the clipping plane if the result is indicative of a cache miss; and
storing the new clipped vertex data as new cached vertex data and storing the plane identification and the pair of vertex indices as a new cached plane identification and a pair of new cached vertex indices.

11. The method as recited in claim 9 wherein the pair of vertex indices correspond to the pair of vertex data defining the edge of the graphics primitive.

12. The method as recited in claim 9 wherein the determining step provides the result indicative of the cache hit status if the plane identification matches the cached plane identification and the pair of vertex indices match the pair of cached vertex indices.

13. The method as recited in claim 9 wherein the determining step provides the result indicative of the cache miss status if the plane identification does not match the cached plane identification.

14. The method as recited in claim 9 wherein the determining step provides the result indicative of the cache miss status if the pair of vertex indices does not match the pair of cached vertex indices.
